(19) United States
(12) Patent Application Publication
(10) Pub. No.: US 2019/0101154 A1
(43) Pub. Date: Apr. 4, 2019

(54) ENCAPSULATED BALL JOINT SYSTEM FOR PRESSURIZED FLUID PROCESSES

(71) Applicant: ALPHINITY, LLC, Carson City, NV (US)

(72) Inventors: Michael C. Gagne, Carson City, NV (US); Dean C. Richards, Simi Valley, CA (US)

(73) Assignee: ALPHINITY, LLC, Carson City, NV (US)

(21) Appl. No.: 16/087,424

(22) PCT Filed: Mar. 22, 2017
(86) PCT No.: PCT/US2017/023673

§ 371 Date: Sep. 21, 2018

Related U.S. Application Data
(60) Provisional application No. 62/312,363, filed on Mar. 23, 2016.

(51) Int. Cl. F16C 11/06; F16K 11/20; F16K 7/06; F16K 7/07; F16L 27/053

(52) U.S. Cl. CPC F16C 11/0604; F16C 11/0614; F16L 27/053; F16K 7/06; F16K 7/07; F16K 11/20

(57) ABSTRACT

One or more ball joints are incorporated into a device or component that is integrated in a pharmaceutical, biological process, or other hygienic process. The ball joint is located in a rigid housing and includes a socket or cavity that includes a ball that rotates, articulates, or moves within the socket. A flexible conduit passes through the rigid housing and the ball and, in some embodiments, terminates at connecting end (e.g., flanged end, barbed end, disposable aseptic connector end, or the like). Another device may be coupled to the connecting end. The ball joint enables angular and/or axial movement to accommodate misalignment with the connecting components or devices.

### RELATED APPLICATION

This Application claims priority to U.S. Provisional Patent Application No. 62/312,363 filed on Mar. 23, 2016, which is hereby incorporated by reference in its entirety. Priority is claimed pursuant to 35 U.S.C. § 119 and any other applicable statute.

### FIELD OF THE INVENTION

The field of the invention generally relates to fluid-based systems and processes used in the manufacture, production, or capture of products. More specifically, the invention pertains to fluid-based process systems and components thereof used in connection with pharmaceutical, biological applications, or other hygienic process industries.

### BACKGROUND OF THE INVENTION

Many commercial products are produced using chemical as well as biological processes. Pharmaceuticals, for example, are produced in commercial quantities using scaled-up reactors and other equipment. So-called biologics are drugs or other compounds that are produced or isolated from living entities such as cells or tissue. Biologics can be composed of proteins, nucleic acids, biomolecules, or complex combinations of these substances. They may even include living entities such as cells. For example, in order to produce biologics on a commercial scale, sophisticated and expensive equipment is needed. In both pharmaceutical and biologics, for example, various processes need to occur before the final product is obtained. In the case of biologics, cells may be grown in a growth chamber or the like and nutrients may need to be carefully modulated into the growth chamber. Waste products produced by cells may also have to be removed on a controlled basis from the fermentation chamber. As another example, biologic products produced by living cells or other organisms may need to be extracted, concentrated, and ultimately collected. The overall manufacturing process may involve a variety of separate but interconnected processes. For example, a biological product of interest may be produced in one part of the system that requires the addition of certain fluids and reagents. The produced product may need to be extracted in one or more downstream processes using and separation techniques.

Because there are a number of individual processes required to produce the final product, various reactants, solutions, and washes are often pumped or otherwise transported to various subsystems using conduits and associated valves. These systems may be quite cumbersome and organizationally complex due to the large numbers of conduits, valves, sensors, and the like that may be needed in such systems. Not only are these systems visually complex (e.g., resembling spaghetti) they also include many components that are required to be sterilized between uses to avoid cross-contamination issues. Indeed, the case of pharmaceutical and biologic drug preparation, the Federal Food and Drug Administration (FDA) is becoming increasingly strict on cleaning, sterilization or bio-burden reduction procedures that are required for drug and pharmaceutical preparations. This is particularly of a concern because many of these products are produced in batches which would require repeated cleaning, sterilization or bio-burden reduction activities on a variety of components.

In many production systems, various subsystems or subunits are connected together via conduits that carry fluid to and from the various process operations that take place. Quite often, this fluid is under significant pressure. In current systems, various types of tubing are used as conduits to connect various subsystems or units. These include reinforced tubing and unreinforced tubing and tubing made of different materials. There are several drawbacks to using a reinforced conduit such as braided silicone tubing. First, braided silicone tubing cannot be bent with sharp turns or bends. Consequently, braided silicone tubing (or other reinforced conduits) requires long radius sections making the conduit sections very long. This introduces additional organizational complexity in the system with long turning sections of conduit being required. Moreover, these long sections of conduit have significant hold-up volumes. In modern pharmaceutical and biological production processes, the quantity of the final product that is produced during a production process is quite small and represents a significant amount of money. Any residual product that is lost within hold-up volumes can represent a very significant financial loss. It is thus imperative to reduce or minimize hold-up volumes in such operations. The problems mentioned above with reinforced tubing are exacerbated even more when larger diameter tubing is being used. As production systems are scaled-up for larger production volumes, larger diameter conduits are increasingly being used with lower pressure ratings or tubing is being used with additional reinforcement (e.g., multi-braided tubing which is stiff and unable to bend into short turns). Another downside to reinforced silicone or other reinforced tubing is the much higher cost as compared to unreinforced tubing. Unreinforced tubing, however, cannot be used in processes conducted at elevated fluid pressures as the conduit will fail (e.g., the conduit will expand and possibly burst).

A problem with current production systems that use various subsystems or subunits that tend to have rigid or defined geometries is that when these systems or subunits are assembled, there sometimes is a mismatch between adjacent subsystems or subunits that need to be connected to one another. Because of the geometry and/or the rigidity of these components, there can be small offsets between two connecting components which can make assembly, disassembly, and re-assembly difficult and time-consuming. Adjustments may have to be made to other components to ensure that the enough “play” or “slop” is in the system to enable adjacent components to be connected together. This can slow down assembly and production times which should otherwise be avoided.

### SUMMARY

In one aspect of the invention, one or more ball joints are incorporated into a device or component that is integrated in a fluid processing system. The fluid processing system may include a pharmaceutical process, biological process, chemical process, or food process (e.g., dairy applications). The ball joint is located in a rigid housing and includes a socket or cavity that includes a ball that rotates or moves within the socket. A flexible conduit passes through the rigid housing and the ball and terminates at connecting end (e.g., flanged end, barbed end, disposable aseptic connector end). Another device may be coupled to the connecting end. The ball joint enables angular and/or axial movement to accommodate misalignment with the connecting components or devices.

In one embodiment, a ball joint for use with pressurized liquid fluids includes a first rigid housing includes respective halves that mate together to define the first rigid housing, the first rigid housing defining a first passageway located between the respective halves of the first rigid housing, wherein the respective halves of the first rigid housing each have respective socket portions that communicate with the first passageway, that when mated together, define a full or complete socket. The ball joint includes a second rigid housing having respective halves that mate together to define the second rigid housing, the second rigid housing defining a second passageway located between the respective halves of the second rigid housing, wherein the respective halves of the second rigid housing each have respective ball portions that, when mated together, define a ball, wherein the ball of the second rigid housing is disposed in the socket of the first rigid housing. A flexible conduit configured to carry fluid therein is disposed in the ball joint and extending from the first passageway to the second passageway.

In another embodiment, a fluid management device for handling pressurized fluid includes a two-part jacket that includes a first half and a second half joined together via a hinge or friction fit arrangement or secured using a fastener, the first half defining a semi-circular inner surface, the second half defining a semi-circular inner surface, the first half and the second half configured to mate with each other to define a circular passageway through the two-part jacket, wherein the first half and the second half each have respective socket portions located at an end of the two-part jacket that are configured to mate with each other to define a socket. The fluid management device further includes a two-part ball housing that includes a first half and a second half configured to mate and define a ball about an exterior portion of the two-part ball housing, wherein respective inner surfaces of the first half and the second half of the two-part ball housing each define respective semi-circular inner surfaces that define a circular passageway through the two-part ball housing when mated, and wherein the ball is disposed in the socket of the two-part jacket. The fluid management device includes a flexible conduit having a lumen therein dimensioned to carry the pressurized fluid, the flexible conduit disposed within the circular passageways of the two-part jacket and the two-part ball housing.

In still another embodiment, a fluid management device for handling pressurized fluid includes a two-part jacket having a first half and a second half joined together via one or more hinges or a friction fit arrangement or a fastener, the first half defining a semi-circular inner surface, the second half defining a semi-circular inner surface, the first half and the second half configured to mate with each other to define a circular passageway through the two-part jacket, wherein the first half and the second half each have respective socket portions located at both ends of the two-part jacket, wherein the respective socket portions are configured to mate with each other to define sockets at both ends of the two-part jacket. A first ball housing includes a first half and a second half that are configured to mate and define a ball about an exterior portion of the first ball housing, wherein respective inner surfaces of the first half and the second half of the first ball housing each define respective semi-circular inner surfaces that define a circular passageway through the first ball housing when mated, and wherein the ball of the first ball housing is disposed in one of the sockets of the two-part jacket. The fluid management device further includes a second ball housing having a first half and a second half and configured to mate and define a ball about an exterior portion of the second ball housing, wherein respective inner surfaces of the first half and the second half of the second ball housing each define respective semi-circular inner surfaces that define a circular passageway through the second ball housing when mated, and wherein the ball of the second ball housing is disposed in the other socket of the two-part jacket. A flexible conduit having a lumen therein dimensioned to carry the pressurized fluid, is disposed within the circular passageways of the two-part jacket, the first ball housing, and the second ball housing.

In another embodiment, a valve device for handling pressurized fluid includes a two-part manifold having a first half and a second half joined together via a hinge or other connection, the first half defining one or more fluid passages along an inner surface thereof, the second half defining corresponding fluid passages along an inner surface thereof, wherein the first half and the second half are configured to mate with each other to define circular-shaped passages through the two-part manifold, wherein the first half and the second half each have respective socket portions located in ends of one or more of the passages that are configured to mate with each other to define a socket. The device also includes a two-part ball housing having a first half and a second half configured to mate and define a ball about an exterior portion of the two-part ball housing, wherein respective inner surfaces of the first half and the second half of the two-part ball housing each define respective inner surfaces that together define a circular passageway through the two-part ball housing when mated, and wherein the ball is disposed in the socket of the two-part manifold. A flexible conduit having a lumen therein dimensioned to carry the pressurized fluid is disposed within the circular passageways of the two-part manifold and the two-part ball housing. The valve device includes at least one pinch valve disposed on the two-part manifold and configured to pinch the flexible conduit.

In another embodiment, a device for use with pressurized liquid fluids includes a rigid two-piece housing, wherein the rigid two-piece housing includes a socket portion therein. A ball is disposed in the rigid, two-piece housing, the ball having a passageway extending through the ball. A flexible conduit extends through at least a portion of the rigid housing and through the passageway of the ball, wherein the ball has a degree of angular rotation and/or axial movement relative to the rigid two-piece housing.

In still another embodiment, a ball joint is formed for use with a flexible conduit for carrying pressurized fluids. A ball housing is formed about the periphery of the flexible conduit, preferably in two halves that are secured to one another. The flexible conduit with the ball is then placed in a device or housing that has defined therein a socket (or partial socket) which is then closed with another part of the device or housing to form the complete socket. The flexible conduit may also extend through the device or housing in one or more passageways that are dimensioned to carry the flexible conduit. The ball and socket are designed so that the ball cannot be pulled completely out of the socket but is retained therein. In one embodiment, the ball has a degree of angular rotation and/or axial movement relative to the device or housing. In another embodiment, that ball can be locked into a fixed position relative to the device or housing.

### BRIEF DESCRIPTION OF THE DRAWINGS

FIG. 1A illustrates a side view of one embodiment of a ball joint.

FIG. 1B illustrates a cross-sectional view of a ball joint according to one embodiment.

FIG. 1C illustrates a ball joint in four different orientations illustrating how the ball joint can be angled in any number of orientations (e.g., 360° angular rotation).

FIG. 1D illustrates a cross-sectional view of the ball joint of FIG. 1B taken along the line D-D′.

FIG. 2A illustrates another embodiment of a fluid management device that incorporates a ball joint therein.

FIG. 2B illustrates one embodiment of a fastener used to close the two-part jacket.

FIG. 2C illustrates the conduit inside the two-part jacket.

FIG. 2D illustrates another embodiment of a fluid management device with ball joints located at both ends.

FIG. 2E illustrates a flexible conduit used in the embodiment of FIG. 2D.

FIG. 3A illustrates a top view of a valve device incorporating multiple ball joints.

FIG. 3B illustrates a side view of the valve device of FIG. 3A.

FIG. 3C illustrates a view of a facing surface of one half of the two-part manifold.

FIG. 3D illustrates a pinching element that is part of a valve that is used to pinch flexible conduit.

FIG. 4A illustrates a top down view of a jumper according to one embodiment that includes ball joints at either end.

FIG. 4B illustrates a side view of the jumper embodiment of FIG. 4A.

FIG. 4C illustrates an end view of the jumper embodiment of FIG. 4A.

FIG. 4D illustrates a perspective view of the jumper embodiment of FIG. 4A.

FIG. 4E illustrates a view of one end of one half of the two-part jacket of the jumper embodiment of FIG. 4A.

FIG. 4F illustrates a view of flexible conduit contained in one half of the ball housing.

FIG. 4G illustrates a view of the opposing half of the ball housing that is used to form the complete ball housing around the flexible conduit.

FIG. 5A illustrates a top down view of a jumper according to another embodiment that includes ball joints at either end.

FIG. 5B illustrates a side view of the jumper embodiment of FIG. 5A.

FIG. 5C illustrates an end view of the jumper embodiment of FIG. 5A.

FIG. 5D illustrates a perspective view of the jumper embodiment of FIG. 5A.

FIGS. 6A illustrates a top down view of a multi-point jumper arrangement according to one embodiment along with respective end views.

FIG. 6B illustrates a perspective view of the multi-point jumper arrangement of FIG. 6A along with a selected end view.

FIG. 6C illustrates a perspective view of the multi-point jumper arrangement of FIG. 6A in a non-planar, twisted configuration along with a selected end view.

FIG. 6D illustrates a perspective view of the multi-point jumper arrangement of FIG. 6A in another non-planar, twisted configuration along with a selected end view.

FIG. 7 illustrates an embodiment of a generic device incorporating multiple ball joints.

### DETAILED DESCRIPTION OF THE ILLUSTRATED EMBODIMENTS

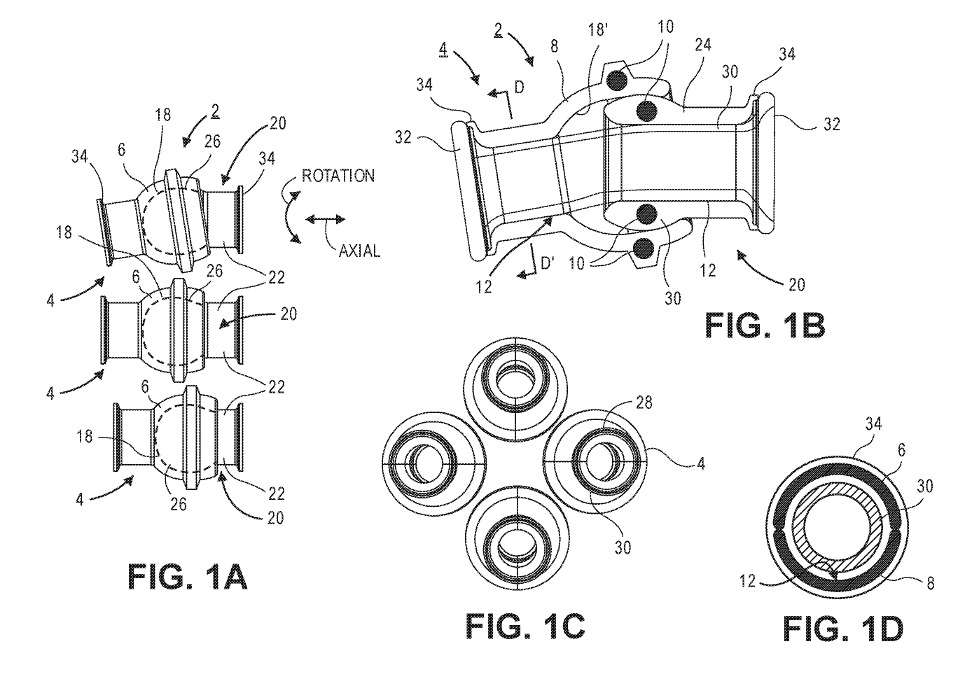

FIGS. 1A-1D illustrate a ball joint 2 according to one embodiment of the invention. The ball joint 2 is used as an interface between two (or more) components of a high pressure, fluid-based process systems that used in connection with pharmaceutical, biological applications, or other hygienic process industries. The ball joint 2, according to one embodiment, includes a first rigid housing 4 that is formed from two parts or halves 6, 8 (FIGS. 1A and 1B illustrate two halves 6, 8) that mate or are joined together to form the completed first rigid housing 4. In one embodiment, the first rigid housing 4 may be formed from a hard, polymer material such as polymer material such as acrylonitrile butadiene styrene (ABS) or other engineered thermoplastic materials suitable for the environment or application. Examples include polyetherimide (PEI), aliphatic polyamides (e.g., Nylon), polyphenylsulfone (e.g., RADEL), etc. Additional materials include standard thermoplastics and polyolefins such as polyethylene (PE) and polypropylene (PP) or a hard plastic such as polyetherimide (PEI) such as ULTEM resins. The housing 4 may also be formed from fluoropolymers such as polyvinylidene fluoride (PVDF) or perfluoroalkoxy (PFA), polytetrafluoroethylene (PTFE), polycarbonate (which may be more thermally resistant), polysulfone (PSU), and the like. In still other embodiments, the housing 4 may be made from a metal or metallic alloy (e.g., stainless steel, steel, bronze, aluminum, alloys of the same, etc.).

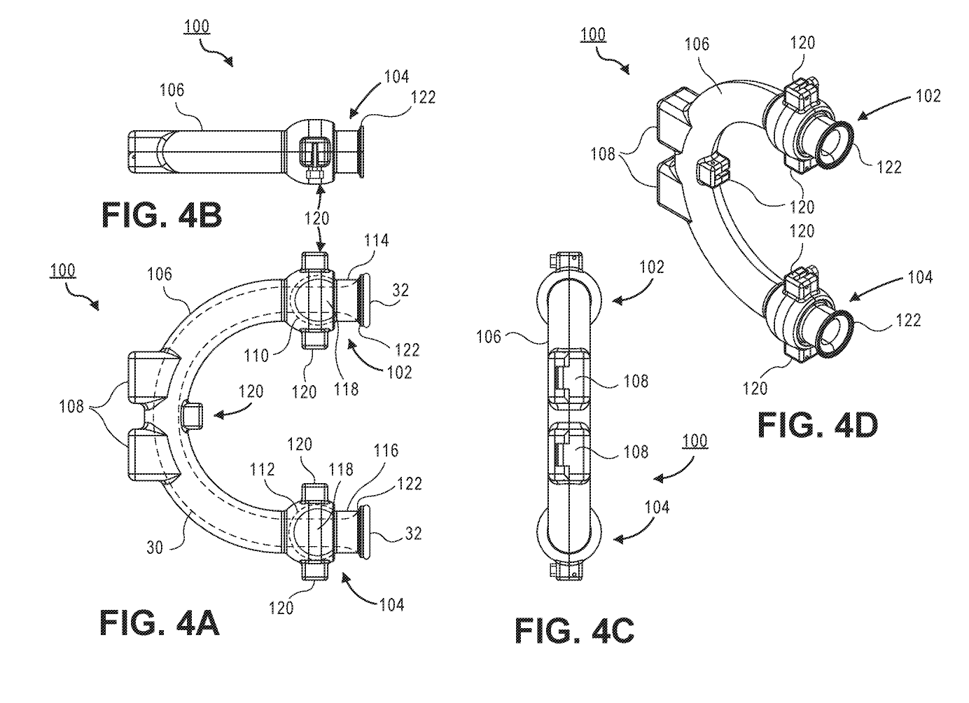

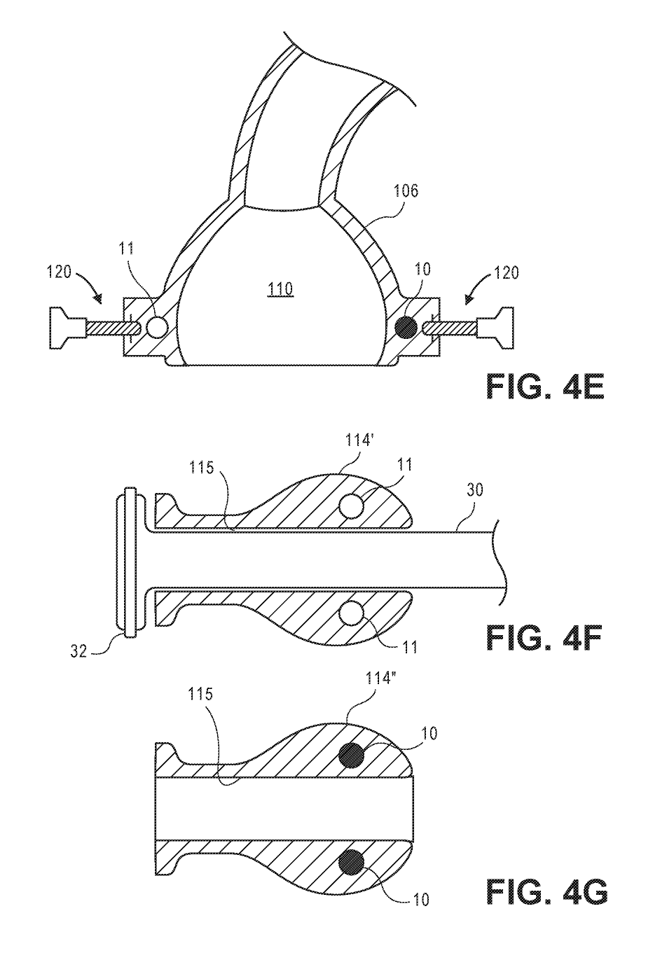

As seen in FIG. 1B, one of the halves 6, 8 (e.g., half 8) of the first rigid housing 4 may include a post 10 or male projection that extends outwardly from the half 8. The other half 6 includes correspondingly located holes 11 or apertures that receive the post 10 (or vice versa) (see FIG. 4E illustrating posts 10 and holes 11). In this manner, the two halves 6, 8 can be secured to one another in an easy manner with the proper orientation. In one embodiment, the post 10 and hole/aperture 11 are dimensioned such that a friction fit or snap fit is formed to keep the two halves 6, 8 together around the flexible conduit (as explained below). In other embodiments, a fastener such as a tie, latch, band, screw, or the like may be used to secure the two halves 6, 8 together.

As best seen in FIG. 1D, the interior of the first rigid housing 4 includes a passageway 12 that, as explained below, is used to hold a flexible conduit 30. The flexible conduit 30, in one embodiment, is formed using a polymer. The flexible conduit 30 may be made from any number of polymer materials including but not limited to polymer thermoplastic elastomers (TPE), thermoplastic rubber (TPR), silicone (thermally or UV-cured), or other polymers (this applies to all embodiments). The flexible conduit 30 is flexible so that it can fit within the first rigid housing 4 and a second rigid housing 20 (described below), that together form the ball joint. The flexible conduit 30 is typically unreinforced but in some embodiments it may have some reinforcement aspects added to it. The passageway 12 generally has a circular cross-sectional profile as most flexible conduits 30 have an external shape that is circular as well. Of course, the cross-sectional shape of the interior may differ so long as it accommodates the exterior shape of the flexible conduit 30 that is positioned therein. The circular-shaped passageway 12 is formed when the two halves 6, 8 of the first rigid housing 4 are brought together (each half 6, 8 has a semi-circular shaped inner surface). The dimension of the passageway 12 is such that the flexible conduit 30 is snugly held therein (e.g., internal diameter of passageway 12 is nearly the same or approximately the same as the outer diameter of the flexible conduit 30). Still referring to FIG. 1B, the interior of the half 8 of the first rigid housing 4 includes a socket portion 18′ that is defined in the inner surface. The socket portion defines part (e.g., one half) of a spherical or spherical-like surface that forms a complete socket 18 (FIG. 1A) when the first half 6 and the second half 8 are jointed together. The actual shape of the inner surface of the socket 18 does not need to be perfectly spherical; rather it is generally spherically shaped with continuously curved surface. In this way, the socket 18 can readily accommodate the ball portion (described below) of the second rigid housing 20 that forms the entire ball joint 2.

FIGS. 1A and 1B illustrate the second rigid housing 20 (e.g., ball housing) that is formed from two parts or halves 22, 24 that mate or are joined together to form the complete second rigid housing 20. The second rigid housing 20 may be formed from a hard, polymer material such as that described above. Alternatively, the second rigid housing 20 may be formed from a metal or metallic material as such as that described herein with respect to the first rigid housing 4. The interior of the second rigid housing 20, like the first rigid housing 4, includes a passageway 12 that is used to hold a flexible conduit 30 that is formed when the halves 22, 24 are mated together. The passageway 12 generally has a circular cross-sectional profile although, as explained above, other profiles may be used. The second rigid housing 20 includes a ball 26 that is formed from respective ball portions 28, 30 that are formed in each of the halves 22, 24. The ball halves 22, 24 may be secured to one another similar to halves 6, 8 as described above with respect to the first rigid housing. Namely, a post 10 or male projection may extend outwardly from one of the ball halves 22, 24 while the other half 22, 24 includes correspondingly located holes 11 or apertures that receive the post 10 (or vice versa).

The ball 26 is formed about the exterior of the second rigid housing 20 and is a round or bulbous structure that is shaped to fit within the socket 18 of the first rigid housing 4 (see FIGS. 1B and 1C). The outer surface of the ball 26 is generally curved or smooth to enable the ball 26 to rotate or undergo articulating motion within the socket 18. The outer surface of the ball 26 is also dimensioned such that it cannot be pulled out axially from the socket 18 after being assembled. To assemble the ball joint 2, the ball 26 of the second rigid housing 20 is placed in socket portion of one half 6, 8 of the first rigid housing 4 and the remaining half 6, 8 of the first rigid housing 4 is then secured to the other paired half to encapsulate the ball 26 in the complete socket 18. In this state, the ball 26 portion of the second rigid housing 20 cannot be pulled out of the open end of the socket 18 because the outer diameter of the ball 26 is larger than the opening of the socket 18.

FIG. 1B illustrates a cross-sectional view showing the flexible conduit 30 that is placed in the ball joint 2. The flexible conduit 30 fits snugly within the passageways 12 of the first and second rigid housings 4, 20. The flexible conduit 30 also extends into the socket 18 and then into the passageway 12 of the second rigid housing 20. As seen in FIGS. 1A and 1B, both the first rigid housing 4 and the second rigid housing 20 include a connecting end 34 that is located at opposing ends of the ball joint 2. In one aspect, the connecting end 34 may include a flange such as that illustrated in FIG. 1B. In this configuration an opposing flange (not shown) is used to abut with the connecting end 34 to form the connecting ends between adjacent components. A conventional clamp or the like may then be clamped around the two mating flanges to form a secure connection. In this configuration, the flexible conduit 30 includes respective flanged ends 32 that are formed to nest within the connecting end 34 (e.g., flange). The connecting ends 34 between adjacent components may be hygienic or otherwise. While flange type ends are illustrated herein, it should be understood that other types of connecting ends 34 may be used will all embodiments disclosed herein. These include, flange ends, barbed ends, disposable aseptic connectors (generic and proprietary). The particular type of connecting end 34 may vary depending on the configuration or setup that is used. The connecting end 34 merely acts as a point of connection to an adjacent component or device and may include any number of types and formats.

FIG. 1C illustrates how the ball joint 2 provides 360° of angular rotation. That is to say, the ball 26 can rotate within the socket 18 so as to adjust the angular orientation of the first rigid housing 4 (with the socket 18) relative to the second rigid housing 20 (with the ball 26) (or vice versa). This provides for the ability to accommodate angular mismatch between connecting components or devices. One can see how the one or both of the first rigid housing 4 and the second rigid housing 20 can be manipulated to provide the desired angular alignment so that adjacent devices and components can be readily attached to each other even if there is some degree of misalignment.

It should be noted that the ball joint 2 in addition to providing angular rotation between the first rigid housing 4 and the second rigid housing 20 can provide some degree of movement in the axial direction (i.e., along the longitudinal direction of the flexible conduit 30). That is to say, the ball joint 2 may shorten or lengthen a bit to accommodate axial alignment. The flexible conduit 30 can accommodate the increased or decreased length. The amount or degree of tolerance depends on how much gap there is between the ball 26 and the socket 18.

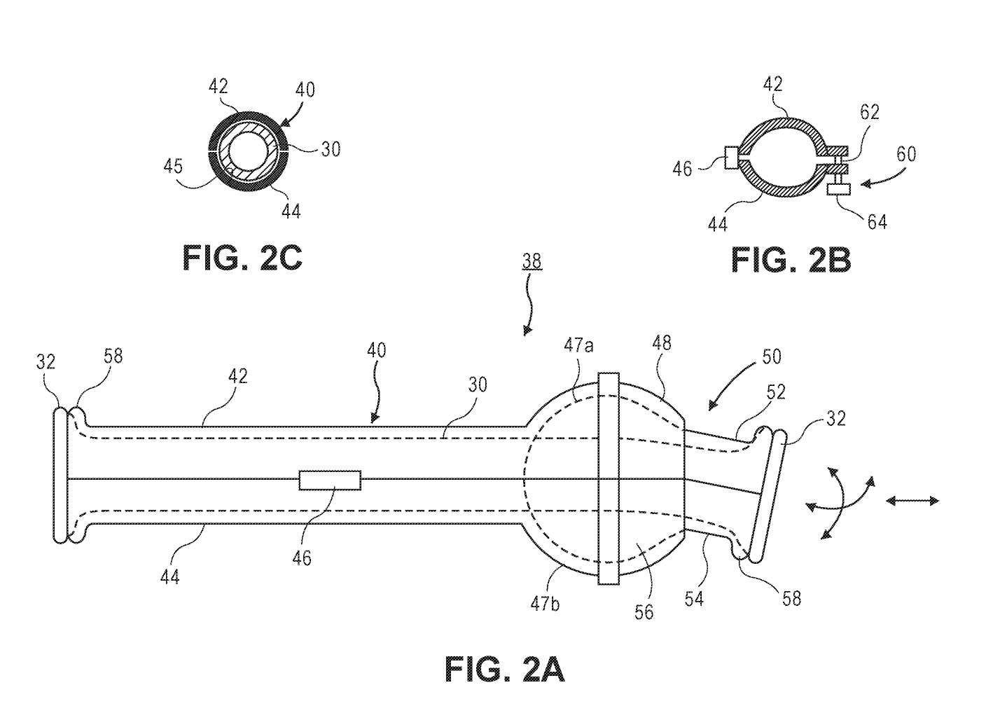

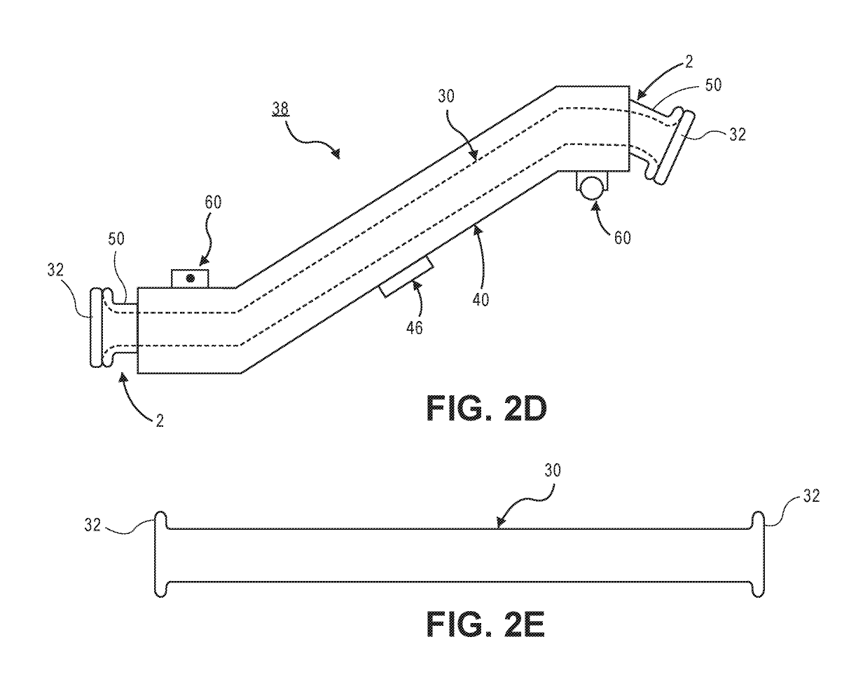

FIG. 2A illustrates another embodiment of a fluid management device 38 that incorporates a ball joint therein. FIG. 2A illustrates a two-part, rigid jacket 40 that acts as an exoskeleton that surrounds and jackets the flexible conduit 30. The rigid jacket 40 may be made from similar materials as described above with respect to the ball joint 2. The two-part jacket 40 includes a first half 42 and a second half 44 that define an inner passageway 45 for the flexible conduit 30 similar to that described herein. That is to say, a circular shaped inner passageway 45 is formed (that holds the flexible conduit 30) when the two-part jacket 40 is in a closed state. The two halves 42, 44 are connected by one or more hinges 46. The two-part jacket includes at one end thereof a socket 48. The socket 48 is formed from two socket portions 47a, 47b that are formed in the inner surfaces of the two-part jacket 40 at an end of the two-part jacket 40. The socket portions 47a, 47b communicate with the main passageway 45 and define the inner surface of the socket 48. The two-part jacket 40 is thus used to form the socket portion 48 of a ball joint 2 that is located at an end thereof. Still referring to FIG. 2A, a ball housing 50 interfaces with the socket 48. The ball housing 50 includes a first half 52 and second half 54 that mate together like as described above with respect to the embodiment of FIGS. 1A-1D (e.g., using posts 10 or male projections that extends outwardly and insert into correspondingly located holes 11 or apertures that receive the posts 10). The first and second halves 52, 54 also define a passageway 45 there for receiving the flexible conduit 30. The first and second halves 52, 54 further include a bulbous ball portions on the exterior thereof that form a ball 56 that resides within the socket 48. In this regard, there is 360° of angular freedom between the ball housing 50 and the two-part jacket 40. While one ball joint 2 is located at one end of the two-part jacket 40, in other embodiments, ball joints 2 may be located at both ends of the two-part jacket 40.

As seen in FIG. 2A, both the two-part jacket 40 and the ball housing 50 have connecting ends 58. The connecting ends 58 may be in the form of a flange or the like that can mate with another flange and clamped together via a standard clamps. FIG. 2A illustrates the conduit 30 also with flanged ends 32 that are formed to nest within the connecting ends 58. The two-part jacket 40 and optionally the ball housing 50 may be held together via one or more fasteners 60. FIG. 2B illustrates one type of fastener 60 which includes a hinged latch 62 with a rotatable knob 64 that can be tightened on the shaft of the latch 62 to secure to the two halves 42, 44 together (or loosened to open the two-part jacket 40). A similar fastener 60 can be used on the ball housing 50 although other fasteners 60 can also be used. In some embodiments, there is no need for a fastener 60 as the first and second halves 52, 54 may be held together using a friction or snap fit arrangement. FIG. 2C illustrates the flexible conduit 30 inside the two jacket halves 42, 44.

FIGS. 2D and 2E illustrate another embodiment of a fluid management device 38 that includes a two-part jacket 40 that surrounds a flexible conduit 30. The general construction of the two-part jacket 40 is similar to the embodiment described in FIGS. 2A-2C. Both ends of the two-part jacket 40 include respective ball joints 2 as illustrated. The two-part jacket 40 is angled in this embodiment and provides a degree of lateral offset. The two-part jacket 40 may also be curved instead of angled to provide for lateral offset. The two-part jacket 40 can be held together using fasteners 60 as explained above. The flexible conduit 30 is illustrated both inside the two-part jacket 40 and outside the two-part jacket 40. The flexible conduit 30 is flexible so that it can be readily placed inside the two-part jacket 40 and in each of the ball joints 2.

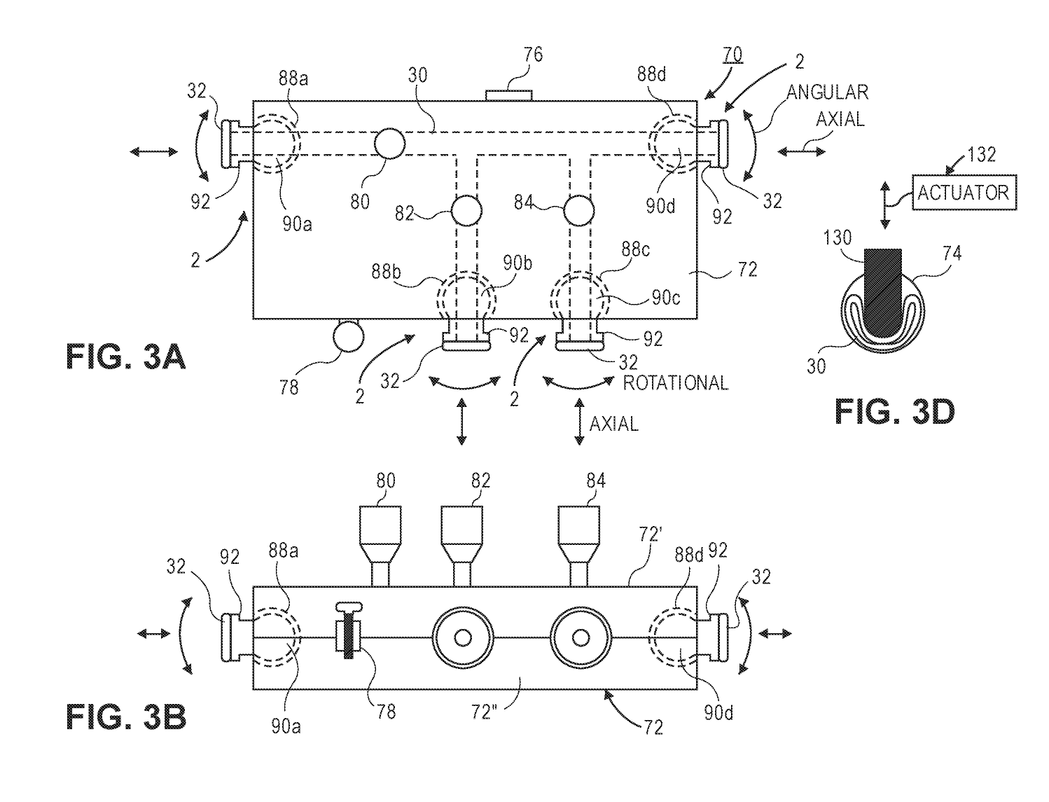

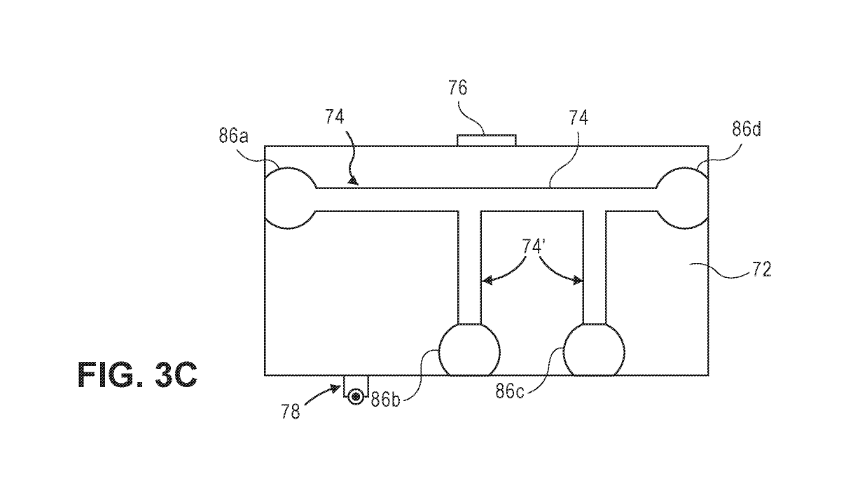

FIGS. 3A-3C illustrates another embodiment of the invention. In this embodiment, one or more ball joints 2 are incorporated into a valve device 70. The valve device 70 includes a two-part manifold 72 that is made of a hard material (e.g., polymer material or even metal including materials disclosed herein) that has formed therein on facing surfaces one or more fluid passageways 74, 74′ (FIG. 3C) such that when the two-part manifold 72 is mated together, the passageways 74, 74′ form circular passageways that will hold the flexible conduit 30 (FIGS. 3A and 3B) as previously described herein. The flexible conduit 30 is thus snugly held within the passageways 74, 74′ formed between the facing surfaces of the two-part manifold 72. FIG. 3C illustrates one such facing surface of one half of the two-part manifold 72. FIG. 3B illustrates a side view illustrating the first half 72′ and second half 72″ that form the two-part manifold 72. The two-part manifold 72 may be held together via one or more hinges 76 and the manifold 72 can be secured using a fastener 78 like that illustrated in FIGS. 3A-3C or FIG. 2B or FIG. 4E. Because this is a valve embodiment, there may be a main or common passageway, 74 along with one or more branch passageways 74′.

In this embodiment, there are multiple pinch valves 80, 82, 84 located at various positions on the two-manifold 72. One pinch valve 80 is used to close/open fluid flow through the flow path along the common passageway 74. The pinch valve 80 closes or stops fluid by compressing the flexible conduit 30 (FIG. 3D) that is positioned beneath a pinching element 130 associated with each pinch valve 80. The two other pinch valves 82, 84 are located along the branch passageways 74″. Thus, each valve 82, 84 can be used to open/close flow to a particular branch pathway 74′. The valves 80, 82, 84 may be any type of pinch valve including automatic pinch valves (e.g., pneumatically operated) or they may be manually operated pinch valves. As seen in FIG. 3D, an actuator 132 (which may be manually or automatic) moves the pinching element 130 in the direction of the arrow to selectively pinch the flexible conduit 30.

Still referring to FIGS. 3A-3C in this embodiment, the inner surfaces of the two-part manifold 72 include respective half socket portions 86a,86b, 86c, 86d (FIG. 3C) that are used, when combined, to create full sockets for each terminal end where the flexible conduit 30 leaves the valve device 70. Since each half of the two-part manifold 72 includes the respective half socket portions 86a,86b, 86c, 86d (FIG. 3C), when placed together in the two halves form the complete sockets 88a, 88b, 88c, 88d. Each of these sockets 88a, 88b, 88c, 88d hold a respective ball housing 90a, 90b, 90c, 90d that are used for each ball joint 2. Each ball housing 90a, 90b, 90c, 90d is formed from two halves (like prior embodiments) and surrounds the flexible conduit 30. When assembled and placed inside their respective sockets 88a, 88b, 88c, 88d, each ball housing 90a, 90b, 90c, 90d is able to move angularly within their sockets 88a, 88b, 88c, 88d as described previously (e.g., 360° angular movement as represented by arrows). In addition, each ball housing 90a, 90b, 90c, 90d may also provide for some axial movement for axial misalignment. As seen in FIGS. 3A and 3B, in this embodiment, each ball housing 90a, 90b, 90c, 90d ends in a connecting end 92 (e.g., flange). FIGS. 3A and 3B also illustrate flanged ends 32 for the conduit 30 that are located adjacent or nested within the connecting end 92. Note that in an alternative embodiment, one or more pinch valves 80, 82, 84 may be omitted entirely. In this case, the ball joints 2 may be located in a bare manifold 72 or a manifold 72 with one or more sensor(s) located therein or a manifold 72 with a different number of pinch valves 80, 82, 84.

FIGS. 4A-4G illustrate another embodiment of a fluid management system 100 that incorporates ball joints 102, 104 at either end. In this embodiment, the fluid management system 100 is a “jumper” that moves fluid from one point to another. The jumper 100 includes two separate ball joints 102, 104 at either end. Thus, there is a certain degree of slop or freedom of movement that allows the jumper ball joint ends 102, 104 to connect to respective connecting points. The jumper 100 includes a two-part jacket 106 that is U-shaped as best seen in FIGS. 4A and 4D. The two-part jacket 106 is formed from a rigid material as explained herein and is used as an exoskeleton or an encapsulating jacket around a flexible conduit 30 that is contained inside and carries the pressurized fluids. FIG. 4A illustrates the flexible conduit 30 located inside the two-part jacket 106. The two-part jacket 106 includes a pair of hinges 108 that allow the two-part jacket 106 to open up (e.g., to load, remove, and replace the inner flexible conduit 30). At the two ends of the two-part jacket 106 there located sockets 110, 112 that are formed in the interior surfaces of the two-part jacket 106. Respective ball housings 114, 116 which act as connecting elements are located in the sockets 110, 112. Each ball housing 114, 116 is formed of halves as seen in FIGS. 4F and 4G (like the prior embodiments) and is pressed together around the flexible conduit 30 to form the completed ball housing 114, 116 using, for example, posts and holes in a friction or press-fit arrangement as described herein. Each ball housing 114, 116 has at one end a ball 118 that interfaces with the sockets 110, 112 to provide for angular and/or axial movement. The sockets 110, 112 have an internal surface that is smooth and generally circular or curved as explained with respect to the prior embodiments. In addition, the ball 118 of each ball housing 114, 116, likewise has a smooth, curved or circular shape as explained in the prior embodiments. Note that dimensions of the socket 110, 112 may be such that the ball 118 retains the ability to rotate and move slightly within the respective sockets 110, 112 after the two-part jacket 106 has been secured shut by the fasteners (discussed below). Thus, in this embodiment, the ball joints 102, 104 can move or articulate once the two-part jacket 106 is closed. Alternatively, the dimensions of the socket 110, 112 may be such that the ball 118 is locked within the respective sockets 110, 112 after the two-part jacket 106 has been secured shut by the fasteners (discussed below). In yet another alternative, a locking member located on the two-part jacket 106 may be used to lock the ball 118 into position. This may include, for example, one or more screws or threaded members that tightened (or loosened) to engage with the ball 118 to prevent rotation of the same. In these embodiments, the ball joints 102, 104 provide flexible during assembly or disassembly but are otherwise locked into place when secured in the jumper 100 (the ball joints 102, 104 may still provide some slight movement in response to fluid pressure effects and the like). The locking configuration may be formed, for example, by a friction fit between the balls 118 and the sockets 110, 112. These two options about loose ball joints 102, 104 or locking ball joints 102, 104 also apply to all other embodiments discussed herein.

There are a number of fasteners 120 that are located on the two-part jacket 106. The fasteners 120 illustrated use a pivoting latch with a knob that can be tightened/loosened on the threaded shaft like that illustrated in FIG. 2B. In the embodiment of FIGS. 4A-4D, the ends of the ball housing 114, 116 include connecting end 122. This is a flanged end as illustrated in FIGS. 4A-4E. The flexible conduit 30 is illustrated in FIGS. 4A and 4F shows the conduit 30 passing through the ball joints 102, 104 and terminating at flanged ends 32. In this embodiment, the jumper 100 can be used to connect one device or port to another. A benefit of this jumper 100 is that any misalignment (angular or axial) can be accommodated because of the ball joints 102, 104 located at both ends. While both ends have ball joints 102, 104 in the jumper 100 embodiment of FIGS. 4A-4G, in some other embodiments, only one end may need a ball joint 102 or 104. One ball joint 102 may be sufficient to adjust for any misalignment.

FIG. 4E illustrates an end of one half of the two-part jacket 106 to reveal the socket 110 which is used to receive the ball 118 which is formed using two ball housings 114′, 114″ as seen in FIG. 4F. As seen in FIG. 4E, the two-part jacket 106 half that is illustrated includes a post or dowel 10 as well as a hole or aperture 11. These are used to mate with a corresponding post/dowel 10 and hole/aperture 11 that is located in the other half of the two-part jacket 106 (not shown) and keep the two-part jacket 106 secured together using a friction interface or friction fit. As illustrated, fasteners 120 (e.g., pivoting threaded latch and knob) may also be used to secure the two-part jacket 106 in the closed state.

With reference to FIGS. 4F and 4G, each ball housing 114′, 114″ includes a semi-circular shaped inner surface 115 that is dimensioned to accommodate the flexible conduit 30 as seen in FIG. 4F. Of course, other shapes are contemplated and are dictated by the outer shape of the flexible conduit 30. The flexible conduit 30 is snuggly retained in the annular spaces defined by the two mating inner surfaces 115. As seen in FIGS. 4F, one ball housing half 114′ includes holes or apertures 11. The other ball housing half 114″ includes posts or dowels 10 that extend from the surface and is dimensioned to fit snuggly within the holes or apertures 11 in the opposing housing half 114′ to create the complete ball housing 114. Note that any combination of posts 10 and holes 11 in both or either of the housing halves 114′, 114″ can be employed. The ball housing 114 is placed inside the socket 110 and the other half of the two-part jacket 106 (not shown) is secured over the ball 118 to create the ball joint 102 that is illustrated, for example, in FIG. 4A.

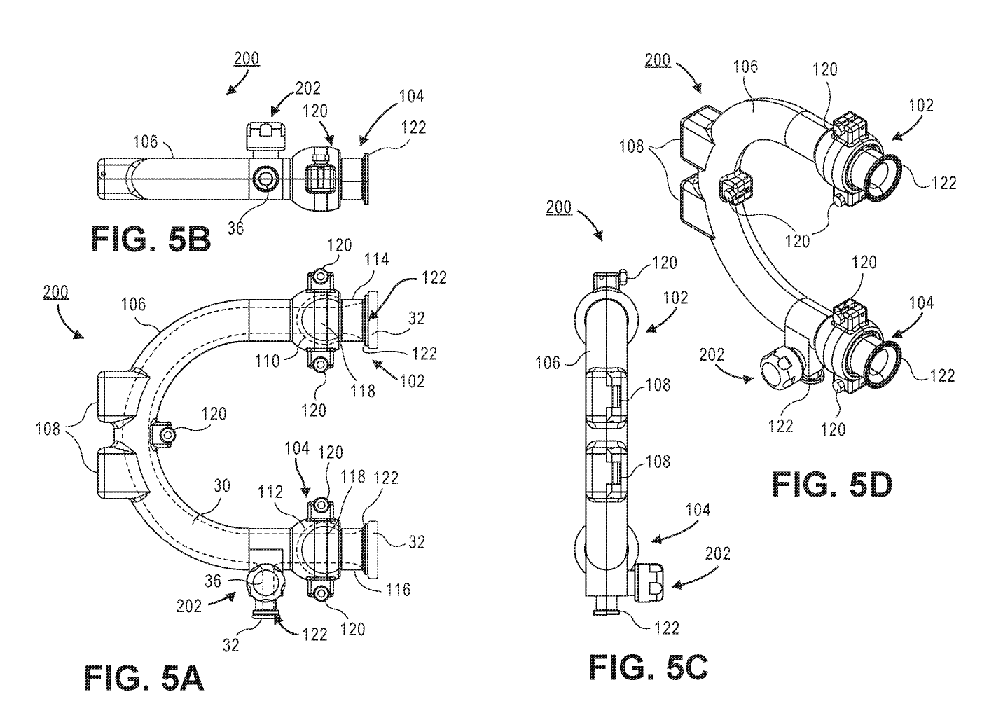

FIGS. 5A-5D illustrate another embodiment of the invention. This embodiment illustrates a jumper 200 that is an alternative embodiment or modification of the embodiment of FIGS. 4A-4D. For FIGS. 5A-5D, the common elements with those of FIGS. 4A-4D are illustrated with the same reference numbers. In this embodiment of the jumper 200, a pinch valve 202 is added that pinches a sample or drain line 36 that extends off the main conduit 30. The pinch valve 202 can be a pinch valve like that illustrated in FIG. 3D. The pinch valve 202 may be automatic or manual and pinches the branch/drain line 36. FIG. 5A illustrates a manually operated pinch valve 202 whereby a bonnet is rotated to close/open the pinch valve 202. The pinch valve 202 may be a separate component or device that is interposed between the two-piece jacket 106 and the ball joint 104. Alternatively, the pinch valve 202 may be incorporated into the two-piece jacket 106. As seen in FIG. 5A, the pinch valve 202 includes a connecting end 122 that can be used to connect to other components or devices. The branch/drain line 36 may also include a corresponding flange 32 that fits within or adjacent to the connecting end 122.

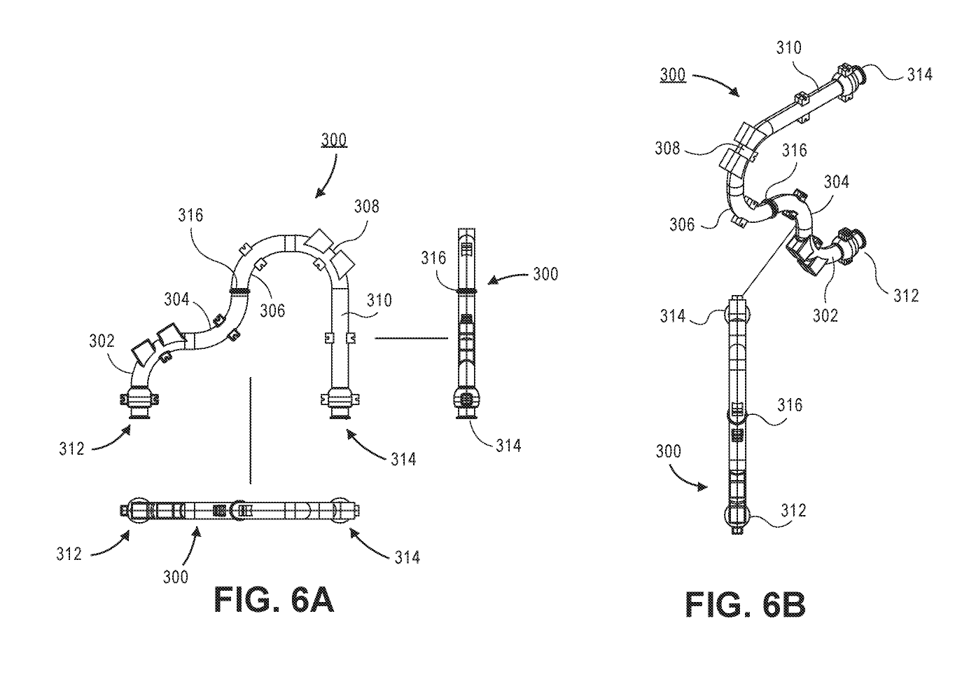

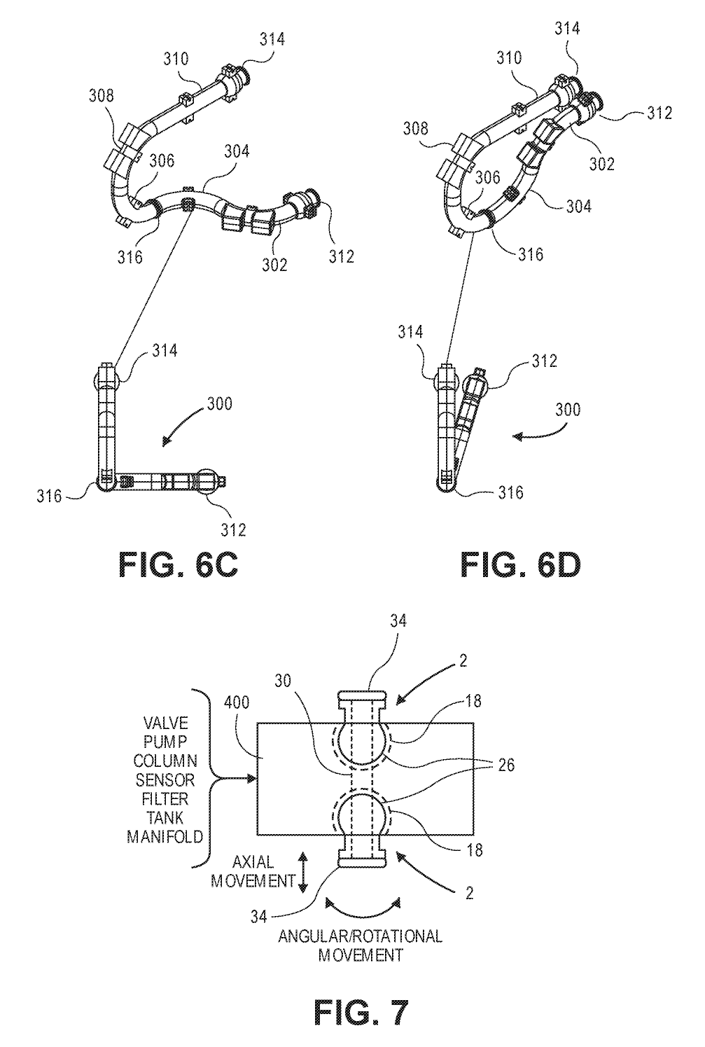

FIGS. 6A-6D illustrate another embodiment of the invention. This embodiment illustrates a multi-point jumper 300 embodiment that includes a number of different two-part jackets 302, 304, 306, 308, 310 that are secured to one another at connection points with the outermost or end jackets 302, 310 containing ball joints 312, 314 at the end thereof The construction of the ball joints 312, 314 is as explained herein in that each ball joint 312, 314 includes a cavity that is formed in the end of the respective jacket 302, 310 and respective ball housings that include a ball are located inside the respective cavities and provide angular and/or axial freedom of movement to accommodate misalignment for connects at the end of the jumper 300. As illustrated in FIG. 6A, adjacent jackets 302, 304, 306, 308, 310 may be connected to one another by mating connecting ends that are secured to one another via conventional clamps 316. The clamp 316 is positioned about the periphery of the adjacent jackets (e.g., jackets 304, 306) and can be tightened to form a secure connection. The clamp 316 may be loosened for disassembly of the jumper 300 (e.g., to replace inner flexible conduit (not illustrated)).

As with the prior embodiments, the internal surfaces of the two-part jackets 302, 304, 306, 308, 310 define a passageway that accommodates a flexible conduit 30 such as the flexible conduits 30 described in prior embodiments. The flexible conduit 30 extends through the two-part jackets 302, 304, 306, 308, 310 and terminates in connecting ends which may include flanges as described herein (the connecting ends are held against or within respective flanges located at the connecting ends of the two-part jackets 302, 304, 306, 308, 310. Note that as seen in FIGS. 6A-6D, the jumper 300 can be configured in a number of geometric arrangements. Different geometric arrangements are formed by rotating the one or more of the two-part jackets 302, 304, 306, 308, 310 relative to one another (best seen in FIGS. 6B, 6C, and 6D). In some embodiments, connections between adjacent two-part jackets may use interlocking fittings using, for example, male and female ends (e.g., flanges, protuberances, recesses, grooves, that enable adjacent two-part jackets to be connected to one another). Examples of these types of connections may be found in International Publication No. WO2016/100396, which is incorporated by reference herein. The interlocking fittings may include tongue and groove interfaces that connect adjacent two-part jackets. In some embodiments, the interlocking fittings still permit relative rotation between the two components. While FIGS. 6A-6D illustrate five (5) different two-part jackets 302, 304, 306, 308, 310 that form the jumper 300 it should be understood that different numbers of two-part jackets may be used. In addition, the shapes of the two-part jackets may be varied. Some jackets may be straight, curved, U-shaped, S-shaped, etc.

FIG. 7 illustrates another embodiment of the invention. In this embodiment, a particular device 400 or component that is incorporated into a pharmaceutical, biological, chemical, food or other hygienic process includes one or more ball joints 2 therein. The device 400 may include any number of devices or components that are used in these applications. By way of illustration and no limitation this includes devices 400 such as valves, pumps, columns, sensors, filters, tanks, manifolds, and the like. All that is required is that a cavity 18 is formed in the device 400 that holds a ball 26 of the ball joint 2. Of course, the device 400 may include one or more ball joints 2. Typically, the cavity 18 is formed in a rigid housing, and in particular a two-part housing so that the ball 26 can be inserted into the cavity 18 by removal or opening of one of the respective halves. Note that the two-part housing that is incorporated into the device 400 does not need to include a full or complete housing for the entire device 400. Just a portion of the device 400 (e.g., panel or the like) may include a two-part housing so that ball 26 can be inserted into the cavity 18.

At least a portion of the flexible conduit 30 passes through ball joint 2 and may optionally terminate in a connecting end 34 as illustrated. FIG. 7 illustrates the flexible conduit 30 passing through two ball joints 2 but it should be appreciated that the flexible conduit 30 may include a single segment, multiple segments, branches, and the like and depends on the particular configuration and use by the device 400. The flexible conduit 30, which used in connection with the ball joint 2, permits a degree of play or slop lets other components and devices connect to the device 400 such that small offsets may be accommodated. In some embodiments, after the connection is made to the ball joint 2 by the connecting component, the ball joint 2 may be fixed in place to “lock” the connection in place. In other embodiments, the ball joint 2 may be allowed to articulate or engage is small axial movement.

While embodiments of the present invention have been shown and described, various modifications may be made without departing from the scope of the present invention. It should be understood that various aspects of one embodiment may be interchangeably be used in other embodiments even though they are not expressly disclosed herein. In addition, various methods of connecting two-part jackets to one another or to other components (e.g., valves) have been disclosed herein. Some methods rely on clamps that surround adjacent flanges to connect adjacent components. Other methods described herein use a “male” protuberance or end in one component that fits into a corresponding “female” groove, recess, or aperture of an adjacent component. Some methods using the male and female arrangement permit rotation between two adjacent components. It should be noted that these are alternative methods to secure adjacent components to one another and that these can be substituted for one another. In this manner, regardless of the particular interface used to connect adjacent components specifically described herein and illustrated in the drawings it should be understood that different attachment schemes can be employed (or substituted) with other described embodiments. Likewise, while various embodiments illustrate hinges holding together the two-part jackets an alternative would be to omit the hinge(s) and use a dowel/recess construction. That is to say that a dowel or post extends from one half of the structure (e.g., housing) and into a recess, aperture, or hole on an opposing half of the structure (e.g., housing). The dowel/recess alternative could be used in other embodiments described herein. The invention, therefore, should not be limited, except to the following claims, and their equivalents.

1-7. (canceled)

8. A fluid management device for handling pressurized fluid comprising:
a two-part jacket comprising a first half and a second half joined together via a hinge or friction fit arrangement, the first half defining a semi-circular inner surface, the second half defining a semi-circular inner surface, the first half and the second half configured to mate with each other to define a circular passageway through the two-part jacket, wherein the first half and the second half each have respective socket portions located at an end of the two-part jacket that are configured to mate with each other to define a socket;
a two-part ball housing comprising a first half and a second half configured to mate and define a ball about an exterior portion of the two-part ball housing, wherein respective inner surfaces of the first half and the second half of the two-part ball housing each define respective semi-circular inner surfaces that define a circular passageway through the two-part ball housing when mated, and wherein the ball is disposed in the socket of the two-part jacket; and
a flexible conduit having a lumen therein dimensioned to carry the pressurized fluid, the flexible conduit disposed within the circular passageways of the two-part jacket and the two-part ball housing.

9. The fluid management device of claim 8, wherein the two-part jacket and the two-part ball housing have a degree of angular rotation and/or axial movement relative to each other.

10. The fluid management device of claim 8, further comprising at least one fastener disposed on at least one of the first half or the second half of the two-part jacket.

11. The fluid management device of claim 8, further comprising at least one fastener disposed on the two-part ball housing.

12. The fluid management device of claim 8, wherein the two-part jacket and the two-part ball housing comprise a polymer material.

13. The fluid management device of claim 8, wherein the two-part ball housing defines a connecting end at an end thereof, the connecting end comprising one of a flanged end, a barbed end, and a disposable aseptic connector end.

14. A fluid management device for handling pressurized fluid comprising:
a two-part jacket comprising a first half and a second half joined together via one or more hinges or a friction fit arrangement, the first half defining a semi-circular inner surface, the second half defining a semi-circular inner surface, the first half and the second half configured to mate with each other to define a circular passageway through the two-part jacket, wherein the first half and the second half each have respective socket portions located at both ends of the two-part jacket, wherein the respective socket portions are configured to mate with each other to define sockets at both ends of the two-part jacket;
a first ball housing comprising a first half and a second half and configured to mate and define a ball about an exterior portion of the first ball housing, wherein respective inner surfaces of the first half and the second half of the first ball housing each define respective semi-circular inner surfaces that define a circular passageway through the first ball housing when mated, and wherein the ball of the first ball housing is disposed in one of the sockets of the two-part jacket;
a second ball housing comprising a first half and a second half and configured to mate and define a ball about an exterior portion of the second ball housing, wherein respective inner surfaces of the first half and the second half of the second ball housing each define respective semi-circular inner surfaces that define a circular passageway through the second ball housing when mated, and wherein the ball of the second ball housing is disposed in the other socket of the two-part jacket; and
a flexible conduit having a lumen therein dimensioned to carry the pressurized fluid, the flexible conduit disposed within the circular passageways of the two-part jacket, the first ball housing, and the second ball housing.

15. The fluid management device of claim 14, wherein the first and second ball housings have a degree of angular rotation and/or axial movement relative to the two-part jacket.

16. The fluid management device of claim 14, wherein the two-part jacket is straight, curved, or angled.

17. The fluid management device of claim 14, wherein the two-part jacket, the first ball housing, and the second ball housing are formed of a polymer material.

18. The fluid management device of claim 14, wherein the first ball housing comprises an end having a connecting end.

19. The fluid management device of claim 14, wherein the second ball housing comprises an end having a connecting end.

20. The fluid management device of claim 14, further comprising one or more fasteners on the two-part jacket.

21. A valve device for handling pressurized fluid comprising:
a two-part manifold comprising a first half and a second half joined together via a hinge or other connection, the first half defining one or more fluid passages along an inner surface thereof, the second half defining corresponding fluid passages along an inner surface thereof, wherein the first half and the second half are configured to mate with each other to define circular-shaped passages through the two-part manifold, wherein the first half and the second half each have respective socket portions located in ends of one or more of the passages that are configured to mate with each other to define a socket;
a two-part ball housing comprising a first half and a second half configured to mate and define a ball about an exterior portion of the two-part ball housing, wherein respective inner surfaces of the first half and the second half of the two-part ball housing each define respective inner surfaces that together define a circular passageway through the two-part ball housing when mated, and wherein the ball is disposed in the socket of the two-part manifold;
a flexible conduit having a lumen therein dimensioned to carry the pressurized fluid, the flexible conduit disposed within the circular passageways of the two-part manifold and the two-part ball housing; and
at least one pinch valve disposed on the two-part manifold and configured to pinch the flexible conduit.

22. The valve device of claim 21, wherein the two-part ball housing has a degree of angular rotation and/or axial movement relative to the two-part manifold.

23. The valve device of claim 21, wherein the two-part ball housing comprises an end having a connecting end comprising one of a flanged end, a barbed end, and a disposable aseptic connector end.

24. The valve device of claim 21, wherein the first half and the second half each have respective socket portions located in ends of one or more of the passages that are configured to mate with each other to define multiple sockets and wherein each socket contains a two-part ball housing.

25-26. (canceled)

27. The fluid management device of claim 8, further comprising a locking member disposed on the two-part jacket and configured to lock the ball relative to the two-part jacket.

28. The fluid management device of claim 14, further comprising respective locking members disposed on the two-part jacket and configured to lock the ball of the first ball housing and the ball of the second ball housing relative to the two-part jacket.

29. The valve device of claim 21, further comprising a locking member disposed on the two-part manifold and configured to lock the ball relative to the two-part manifold.
